(19) United States
(12) Patent Application Publication
(10) Pub. No.: US 2008/0064245 A1
(43) Pub. Date: Mar. 13, 2008

(54) Device for Connecting an Electric Drive to at Least One Supply Network, and Method for the Production of Such a Connecting Device

(76) Inventors: Thomas Bielesch, Muhlacker (DE); Michael J. Stutz, Radolfzell (DE)

Correspondence Address: GREER, BURNS & CRAIN, 300 S WACKER DR, 25TH FLOOR, CHICAGO, IL, 60606, US

(21) Appl. No.: 11/579,026

(22) PCT Filed: Apr. 28, 2005
(86) PCT No.: PCT/EP05/04587

§ 371 Date: Aug. 23, 2007

(30) Foreign Application Priority Data
Apr. 28, 2004 (DE) 10 2004 020 832.8

(51) Int. Cl. H01R 13/62

(52) U.S. Cl. 439/296; 29/857

(57) ABSTRACT

A device for connecting an electric drive to at least one supply network as well as several methods for producing such a connecting device includes a first contact/terminal unit to which at least one first wire of the supply network can be connected, a second contact/terminal unit to which the electric drive can be connected, and a third contact/terminal unit to which second wire of the at least one supply network can be connected. The first contact/terminal unit is connected to the second contact/terminal unit in such a way that a wire connection can be created between the at least one supply network and the electric drive. The third contact/terminal unit is connected to the first contact/terminal unit or the second contact/terminal unit such that a direct or indirect wire connection can be created between the at least one second wire and the at least one supply network.

The present invention relates to a device for connecting an electric drive to at least one supply network, and to a plurality of methods for manufacturing such a device.

Such a connecting device, a plugging or plug system for connecting an (electric) drive of an electric fan to an electrical system of the motor vehicle, e.g. for a cooling system for cooling the engine of a motor vehicle or for an air-conditioning system for air-conditioning the passenger compartment of a motor vehicle, is known from the prior art.

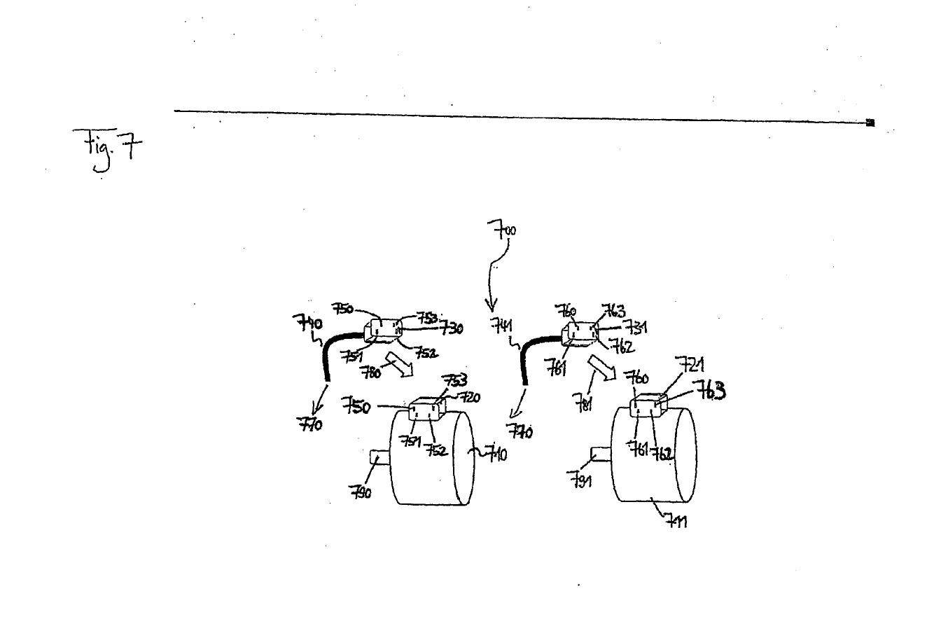

FIG. 7 shows such a plug system 780 or 781 from the prior art for a double-fan system 700 of a motor vehicle cooling module.

In this double-fan system 700, two electric drive units or motors 710, 711 are connected to an electrical system 770 of a motor vehicle, each by this plug system 780, 781 known from the prior art, which is a four-pole plug connection that can be contacted at one side.

Plug system 780, 781 comprises two plug parts, each of which is contactable at one side or pluggable into one another, a three-pole or, as depicted, four-pole electrical system plug connector 730 or 731 that is contactable at one side, and an appurtenant three-pole or, as shown as an example, four-pole mating connector 720 or 721, also contactable at one side.

Electrical system plug connector 730 or 731 is connected to electrical system 770 via a cable 740 or 741. Mating connector 720 or 721 is integrated into electric drive motor 710 or 711, whereby electric drive motor 710 or 711 is connected to mating connector 720 or 721 corresponding to cable 740 or 741 or a connection of this sort.

In the case shown, cable 740 or 741 bundles four lines or wires, two lines being used for the main power supply, in this case (±) lines from a battery power supply. The remaining two lines are control and bus lines of a vehicle electronics system.

For the driving of the respective drive, the corresponding holds for the integrated connection between mating connector 720 or 721 and the respective drive motor 710 or 711.

Given a contacted plugging system 780 or 781, or plug parts 730 or 731 and 720 or 721 that are plugged into one another, the connection between the vehicle electrical system and the (respective) drive 710 or 711 is created via four pole contacts 750 to 753 or 760 to 763, and drive 710 or 711 is supplied via this connection with energy, as well as with control and communication signals.

Correspondingly, the respective drive shaft 790 or 791 is set into rotation, which is transferred to a fan or blower.

This double fan system 700, having two drive units 710 and 711 connected to vehicle electrical system 700 via respective one-sided contactable plug connections 780 or 781, has the disadvantage that each drive unit 710 or 711 is contacted separately to electrical system 700, requiring an increased cabling expense and/or assembly expense, with correspondingly high costs, as well as known electrical and electronic disadvantages.

Many fan drives are controlled by correspondingly expensive interfaces, so that here a higher number of connection lines, in particular control lines and/or bus systems, is required for each fan drive. The associated cabling expense for the fan system as a whole is correspondingly increased.

In addition, in such more expensive fan drives having additional control lines and increased cabling expense, further measures are required to decouple the individual fan drives or fan systems with respect to communication, and also to be able to control them individually. There are also further disadvantages with regard to diagnostic capability.

Corresponding disadvantages are found in simple fan systems, and to a still greater degree in more expensive multiple fan systems, in which a multiplicity of fans or fan drives must each be contacted separately to a vehicle electrical system by means of the plug connection that is contactable at one side.

The present invention is therefore based on the object of creating a plug system, in general a connecting or terminal device, for connecting an electric drive, or also an actuator, to a supply network or to a cabling system, said connecting device enabling a simple and economical cabling with a lower cabling and assembly expense.

In addition, a modular construction, made up of a plurality of fan systems and actuators, is to be enabled.

Moreover, the present invention is intended to make it possible to avoid the above further disadvantages in more expensive fan systems, in particular in multiple-fan systems.

These objects are achieved by the device for connecting an electric drive to at least one supply network and by the method for manufacturing such a device, having the features as recited in the respective independent patent claim.

Preferred specific embodiments and developments are the subject matter of the subclaims.

The device according to the present invention for connecting an electric drive to at least one supply network has a first contact/terminal unit to which at least one first line of the at least one supply network is able to be connected.

In the following, a contact or terminal unit is understood to be a functional element of a contacting, for example a plug contact element having one or more contact points, such as for example a plug contact side of a one-sided contactable plug having pole contacts at this side.

Furthermore, in the following a line is understood to be any type of signal and/or data line, and a supply network is understood to be a contiguous higher-order unit of such lines.

Furthermore, in the following connecting is understood to refer to (functional) contacting.

The device according to the present invention also has a second contact/terminal unit to which the electric drive is able to be connected.

Here it can preferably be provided to integrate the second contact/terminal unit into the electric drive, for example an electric motor.

In addition, the device according to the present invention has a third contact/terminal unit to which at least one second line of the at least one supply network is able to be connected.

This at least one second line can preferably be connected to another electric drive, for example in the context of a double-drive system, as in a double fan.

In the device according to the present invention, the first contact/terminal unit is connected to the second contact/terminal unit in such a way that a line or wire connection is able to be created between the at least one supply network and the electric drive.

Concretely, the electric drive is thus able to be connected to the at least one supply network via the first and the second contact/terminal unit.

The third contact/terminal unit is connected to the first contact/terminal unit or to the second contact/terminal unit in such a way that a direct or indirect line connection is able to be created between the at least second line and the at least one supply network.

Concretely, the connection of the third contact/terminal unit to the first contact/terminal unit realizes a direct connection between the at least second line and the at least first line, or the at least one supply network.

In the case of the connection of the third contact/terminal unit to the second contact/terminal unit, an indirect connection is realized between the at least second line and the at least first line or the at least one supply network. In this case, a direct connection is created between the at least first line or the at least one supply network and the electric drive, and a direct connection is created between the at least second line and the electric drive.

If the at least second line (at the other side) is connected to another drive, as in a double-drive system, the drives are connected in parallel to the at least one supply network (directly in the first case above or indirectly in the second case above).

Concretely, the device according to the present invention realizes a two-sided contactable plug (double plug) having a first, main plug connection to a supply network, for example a vehicle electrical system, as well as a second, additional plug connection to which the at least second line (as well as possible subsystems connected thereto) is (are) able to be connected.

In addition, this two-sided contactable (double) plug is connected to the drive via a third contacting that can be realized so as to be integrated in the electric drive.

Via this third, possibly integrated, contacting, in connection with the first main plug connection, the electric drive can be connected to the supply network.

Via the second additional connecting plug, or via the at least second line, additional subsystems, such as additional electric drive systems or actuators, can be connected in direct or indirect connection to or via the main plug connection.

In this way, multiple-fan systems can be realized in which a multiplicity of fans are each connected to the at least one supply network in parallel, indirectly or directly, by means of the two-sided contactable plug, or by means of the double plug according to the present invention.

In a preferred development of the device according to the present invention, it is provided to connect a plurality of first lines to the first contact/terminal unit and/or to connect a plurality of second lines to the second contact/terminal unit.

Given the connection of a plurality of lines, multiple-pole, in particular two-pole, three-pole, or four-pole, contact systems or plug systems/plug connections can be realized.

As lines, current or voltage supply lines, data or communication lines, control/control signal lines, and/or lines of bus systems can be provided.

In the corresponding cases of lines, the at least one supply network is a power supply network and/or a communication network, in particular a bus system and/or a control network.

The respective lines or supply networks can be components of a vehicle electrical system, in particular a motor vehicle electrical system, or of a vehicle electronics system.

In addition, the first, second, or third contact/terminal unit can be fashioned as a plug contact unit having at least one plug contact.

Such a plug contact unit, or the first, second, or third contact/terminal unit, can be set up in order to receive a contact plug.

In a preferred embodiment, it is provided to install the device in a cooling system for engine cooling and/or in an air-conditioning system for air-conditioning the passenger compartment of a motor vehicle.

In this case, or in these cases, as well as in cases of the connection of a multiplicity of drive or actuators in the double-drive systems, the electric drive can be an electric motor of an electric fan. The actuator can for example be an expanding-material element.

In the method according to the present invention for manufacturing such a device for connecting an electric drive to at least one supply network, a metallic flat conductor is divided along a predeterminable dividing line in a predeterminable area at a first end of the metallic flat conductor.

Preferably, this dividing can take place through mechanical processing of the flat conductor, for example through a slitting or cutting of the metallic flat conductor in this area.

In addition, the metallic flat conductor can preferably be divided along its longitudinal direction in the predeterminable area, i.e., the predeterminable dividing line is the longitudinal direction of the metallic flat conductor.

According to the present invention, the dividing forms a first longitudinal segment of the metallic flat conductor having a first free end and a second longitudinal segment of the metallic flat conductor having a second free end.

Preferably, here it can be provided to bend at least one of the two longitudinal segments around, for example by an angle of approximately 90°. In this way, a more economical and simpler angled plug connector can be realized.

In a particularly preferred specific embodiment, it is provided to bend both longitudinal segments in opposite directions, each by an angle of approximately 90°. In this case, the two longitudinal segments form an angle of approximately 180° to one another, i.e., the two longitudinal segments are situated at least approximately in one plane.

In addition, according to the present invention the first contact/terminal unit is then set up at the first free end, and the second contact/terminal unit is set up at the second free end.

In this way, a kind of double contact can be realized, for example a first contact for a main connecting plug and a second contact for an additional connecting plug.

At the other end, a second end, of the metallic flat conductor, the second contact/terminal unit, for example the connection for the electric drive, is set up.

In another preferred construction, the metallic flat conductor is made of a metal based on copper.

In order to protect the metallic flat conductor, this conductor can be extrusion-coated, in general jacketed or sheathed, in particular with a plastic, at least in the area of its formed ends, i.e. at the first and/or at the second free end of the longitudinal segments and/or at the second end of the metallic flat conductor.

It can also be provided to sheath or to extrusion-coat the metallic flat conductor in part or in its entirety.

In these ways, simple and economical plastic plug connections can be manufactured, as a bent-off shape in the case of only one bent-off longitudinal segment, or as a straight shape in the case of two, i.e. both, longitudinal segments bent off in opposite directions.

In another specific embodiment, it is provided to fashion a contact/terminal unit as a contact jack or sleeve, female contact. This can be realized in such a way that a contact jack is attached to the respective end of the metallic flat conductor, for example by welding.

If such contact jacks are attached at all ends of the metallic flat conductor, a multi-contact plug unit can be realized in this way.

In another, particularly preferred, specific embodiment, the metallic flat conductor is integrated into a distribution apparatus of air guides, and a plug unit is molded on.

With the device according to the present invention, as well as developments thereof, in particular as a plug system having two integrated and multipolar plugs (double plug), inter alia the following can be realized, possibly simultaneously depending on the construction:

A main connecting plug to an electrical system of a vehicle can be realized having corresponding main power supply lines and control or bus lines.

A second, additional connecting plug, to additional drive units or subsystems, such as actuators, can be realized having corresponding main power lines, control lines, and bus lines.

Internal connections of the two plugs named above, i.e. the main connecting plug and the second connecting plug, as well as of the drive with regard to main power supply lines, for example (±) terminals of a battery voltage supply, can be realized.

A supplying or, depending on the design, a connecting of the two above plugs, as well as of the drive, to corresponding control and bus lines of a vehicle electronics system can be realized.

The main connecting plug can be used as a main control input for the first electric drive and for additional drive or drive units or actuators. The second connecting plug can be used as an additional bus system for controlling and communicating with the additional drive units or actuators. Here, a master-slave operation of the drives can be realized.

The plug connections of control lines and bus lines can be designed as bidirectional inputs and/or outputs. These can then be used as sensor inputs or as bus or control lines for external components, such as for example a louver or an expanding-material element.

The control or bus lines can be used for coding for the respective drive (example: right/left drive). An intelligent integration into a fail-safe design for the fan system (louver) can be realized.

A connection of additional drives to a multi-wire additional line can be realized.

In addition to the advantages described up to now, the device according to the present invention, as well as its developments, also has the following further advantages:

A plug for connecting drive systems to a vehicle electrical system that supplies the drive systems with battery voltage and with control lines can be economically realized.

In a minimal case, for example two drives can be operated using only one control line.

All standard bus systems of various manufacturers or customers can be realized by a plug system according to the device of the present invention, for example a PWM interface both with and without terminal 15/87 controlling, a CAN bus, or a LIN bus system.

Using two PWM input signals, two drives, for example for two fans, can be controlled separately with only one plug having at least four poles according to the device of the present invention.

In particular, the device according to the present invention, as well as its developments, makes it possible to reduce cabling expense, for example in a vehicle electronics system.

The manufacturing method according to the present invention, as well as its developments, additionally enables an economical manufacture of the device according to the present invention, in particular a plug system according to the present invention.

Given corresponding design and software modification, the present invention enables drive systems to communicate directly with one another or with the on-board system (vehicle electronics system).

A second plug connector according to the present invention, for example a connector to a second drive unit, can, as needed, also be used only in one-sided fashion (for connecting to the first plug connector according to the present invention, which is used in double-sided fashion to connect to the first drive unit). Here, the second plug side can be sealed with plastic or covered with a dummy plug.

In addition, thermal management of a module and of a fan system can be taken over by means of the present invention through integration of a software unit into the drives.

Contacts of the input or main plug connector, in comparison with contacts of the output or additional plug connector, can be placed at different drive inputs or drive outputs, so that these can be controlled or read independently of one another.

In addition, the present invention makes it possible to integrate protective systems, such as a blocking protection, a fail-safe mode, and/or a diagnostic system, into the drive.

Additional advantages, features, and possible uses of the present invention result from the following description of exemplary embodiments, in connection with the Figures.

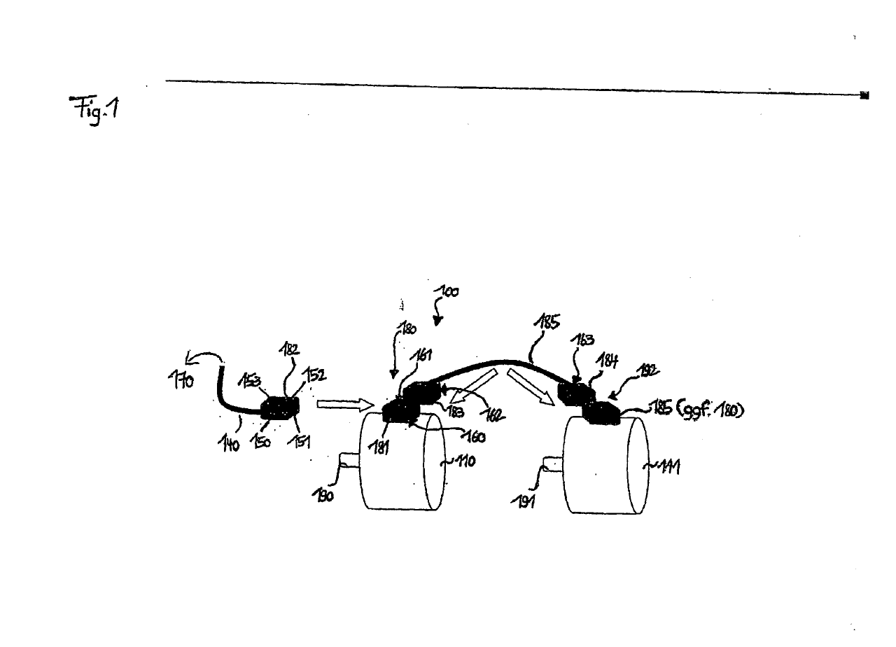

FIG. 1 shows a drawing of a double-fan system having straight plug connections contactable at two sides, according to a first exemplary embodiment of the present invention;

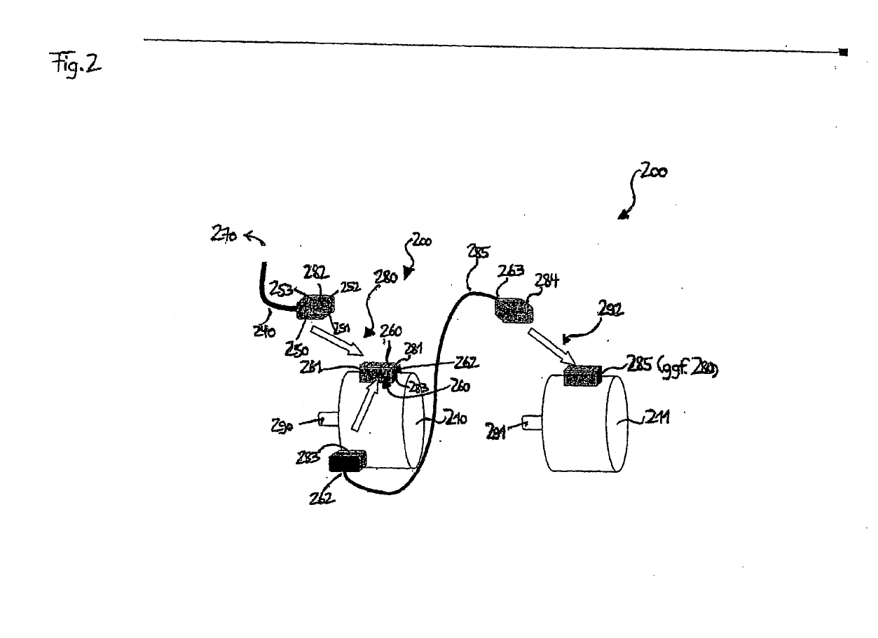

FIG. 2 shows a drawing of a double-fan system having bent-off plug connections contactable at two sides, according to a second exemplary embodiment of the present invention;

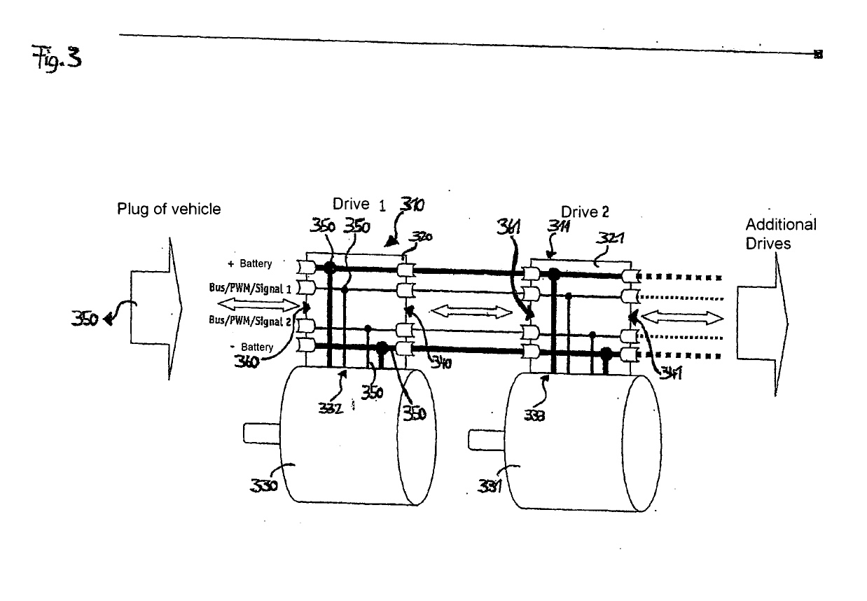

FIG. 3 shows a drawing of a sample switching diagram in a multiple-fan system having plug connections contactable at two sides, according to a third exemplary embodiment of the present invention;

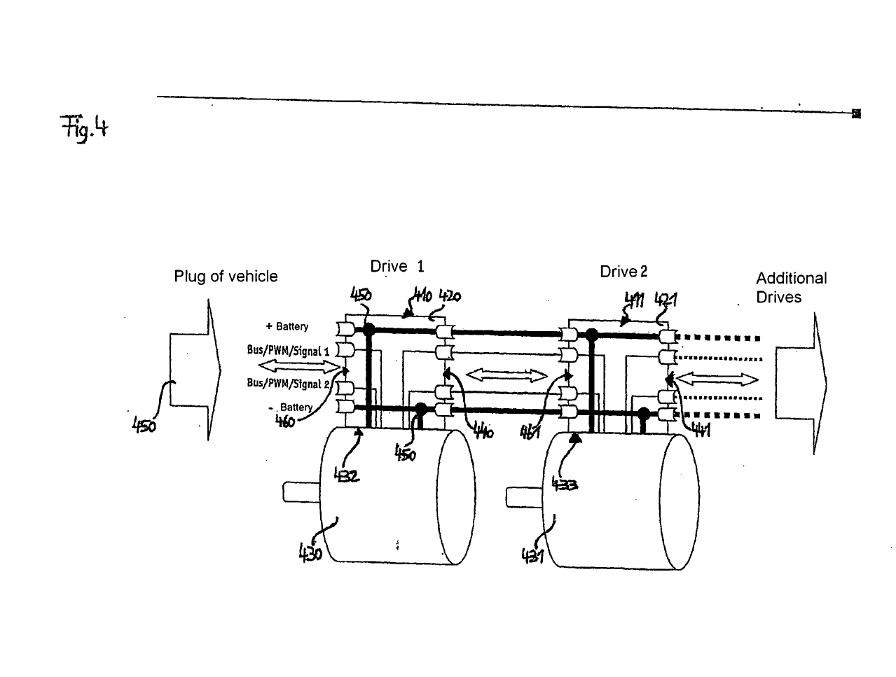

FIG. 4 shows a drawing of a sample switching diagram in a multiple-fan system having plug connections contactable at two sides, according to a fourth exemplary embodiment of the present invention;

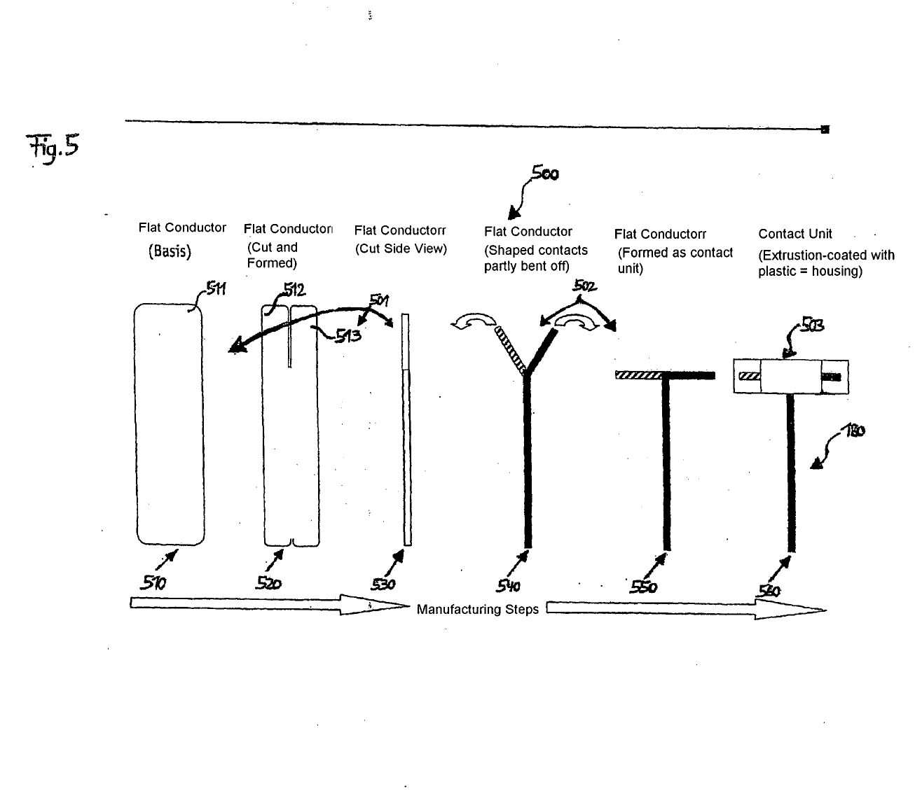

FIG. 5 shows a drawing having manufacturing steps of a manufacturing method according to the present invention for manufacturing a straight plug, contactable at two sides, for a plug connector in the double-fan system according to the first exemplary embodiment of the present invention;

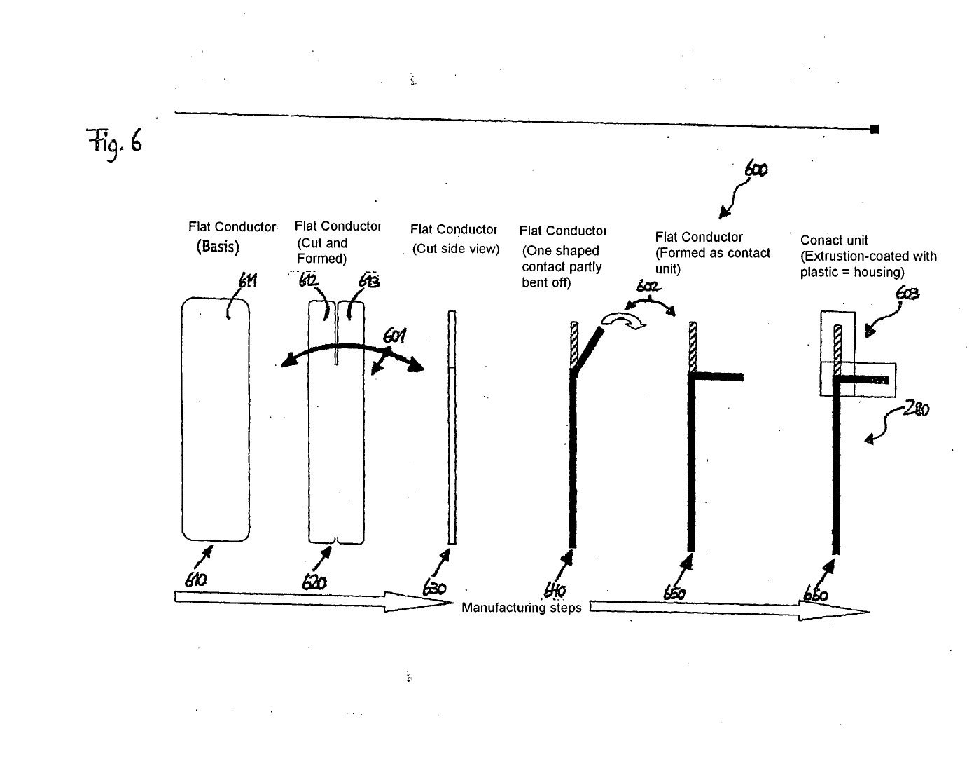

FIG. 6 shows a drawing having manufacturing steps of a manufacturing method according to the present invention for manufacturing a bent-off plug, contactable at two sides, for a plug connector in the double-fan system according to the second exemplary embodiment of the present invention;

FIG. 7 shows a drawing of a double-fan system having plug connections contactable at one side according to the prior art;

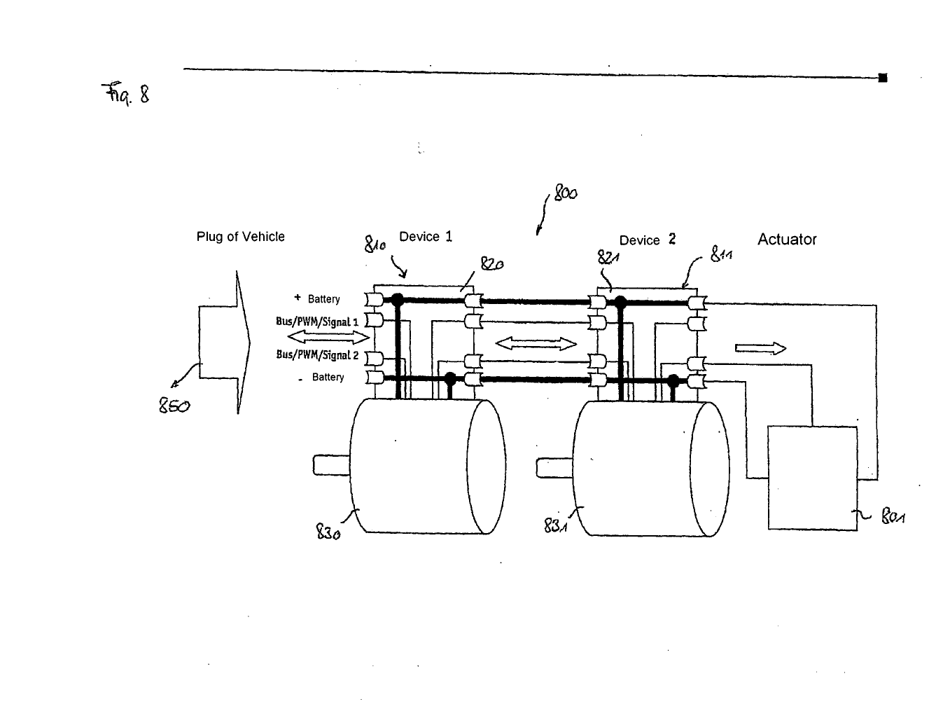

FIG. 8 shows a drawing of a sample switching diagram in a double-fan system having a connected actuator, having plug connections contactable at two sides, according to a fifth exemplary embodiment of the present invention;

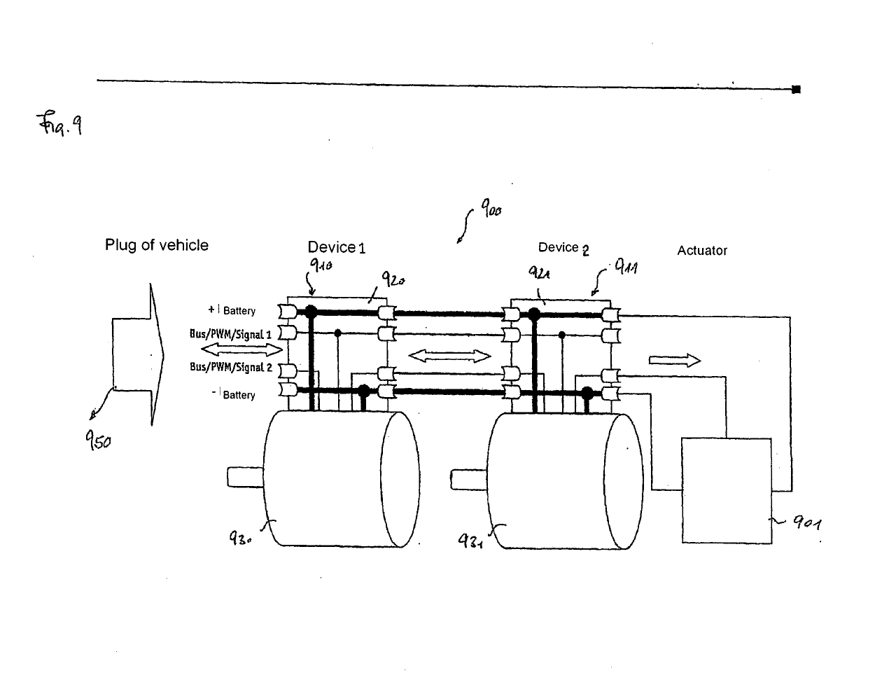

FIG. 9 shows a drawing of a sample switching diagram in a double-fan system having a connected actuator, having plug connections contactable at two sides, according to a sixth exemplary embodiment of the present invention.

A first exemplary embodiment of the present invention, having a straight plug connector contactable at two sides, is described with reference to FIGS. 1 and 5. FIG. 1 shows a drawing of a double-fan system 100 capable of being used in a motor vehicle cooling module, having a straight plug connector 180, contactable at two sides, according to the present invention.

FIG. 5 shows a drawing having manufacturing steps 501 to 503, illustrated by drawings 510 to 560, of a manufacturing method 500 according to the present invention for manufacturing a straight plug 181, contactable at two sides, for plug connection 180 in double-fan system 100 according to FIG. 1.

In this double fan system 100 in FIG. 1, two electric drive units or motors and a first drive 110 and a second drive 111 are connected to an electrical system 170 of a motor vehicle, using the two-sided contactable straight four-pole plugs or plug connections 180 for first drive 110 and a one-sided contactable four-pole plug or plug connection 192 for second drive 111.

The two-sided contactable straight four-pole plug or plug connection 180 comprises, as a central element, a two-sided contactable multipolar plug 181 (double plug) that is integrated into first drive 110.

In addition, two-sided contactable plug connection 180 comprises a four-pole one-sided contactable electrical system plug 182 that is connected at one side to electrical system 170 via a cable 140.

Cable 140 bundles four lines, of which two lines are used for the main power supply, in this case (±) lines of a battery power supply. The remaining two lines are control and bus lines of a vehicle electronics system.

At the other side, electrical system plug 182 can be plugged to a first contact side 160 of two-sided contactable four-pole plug 181.

The connection between the vehicle electrical system and two-sided contactable plug 181 is created by plugged contact between electrical system plug 182 and two-sided contactable straight plug 181, via four pole contacts 150 to 153.

Because this plug 181 is in addition connected to first drive 110 via the integrated connection, first drive 110 is thereby connected to electrical system 170, and is supplied via this connection with energy and with communication and control signals.

Correspondingly, drive shaft 190 is set into rotation, which is transferred to a fan or blower.

In addition, two-sided contactable straight plug connection 180 has a first one-sided contactable four-pole connecting plug 183 that is connected to a connecting cable 185 at the one end 162 thereof.

Connecting cable 185 is constructed in a manner corresponding to (electrical system) cable 140, and likewise bundles the four lines.

At the other end 163 of connecting cable 185, a second one-sided contactable four-pole plug connector 184 is situated.

First plug connector 183 is able to be plugged at a second contact side 161 of two-sided contactable plug 181.

Because first contact side 160 and second contact side 161 of two-sided contactable straight plug 181 are situated on opposite sides of plug 181, what is known as a “straight” plug 181 results.

The one-sided contactable, four-pole plug or plug connection 192 is formed in that second one-sided contactable plug 184 stands in plugged contact with another one-sided contactable plug 185 that is integrated into second drive 111.

Alternatively to the additional one-sided contactable plug 185, here a second two-sided contactable straight plug 181 may be used.

Via this one-sided contactable plug connection 192, connecting cable 185, and additionally via two-sided contactable plug connection 180, second drive 111 is also connected to electrical system 170, and is supplied via this connection with energy and with control and communication signals.

Correspondingly, drive shaft 191 is set into rotation, which is transferred to a blower or fan.

As shown in, for example, FIG. 5, the manufacture 500 of two-sided contactable straight plug 181 for plug connection 180 in double-fan system 100 takes place according to the following steps 501 to 503:

In a first step 501, illustrated by drawings 510 to 530, a flat conductor piece 511 is cut to length and is correspondingly fashioned into a contact shape.

This results in two additional flat conductors 512 and 513, which, in a second step 502, illustrated by 540 and 550, are bent off in opposite directions, at right angles.

If one contact side is now to be formed as a contact jack, this is to be realized through the additional attachment of a contact jack, e.g. by welding.

This is to be carried out in the same manner for all contacts, so that a complete multi-contact plug unit results.

In a third step 503, illustrated by 560, the processed flat conductor piece, formed as a contact unit, is extrusion-coated with plastic, forming a plug housing.

Alternatively, it can be provided to integrate flat conductors, as supply lines to the drives, into the distributor apparatus of the air guides, and to mold on the plug unit.

A second exemplary embodiment of the present invention, having a two-sided contactable bent-off plug connection 280, is now described with reference to FIGS. 2 and 6.

FIG. 2 shows a drawing of a double-fan system 200 capable of being used in a motor vehicle cooling module, having a two-sided contactable bent-off plug connector 280 according to the present invention.

FIG. 6 shows a drawing having manufacturing steps 601 to 603, illustrated by drawings 610 to 660, of a manufacturing method 600 according to the present invention for manufacturing a two-sided contactable, bent-off plug 281 for plug connection 280 in double-fan system 200 according to FIG. 2.

In double-fan system 200 in FIG. 2, two electric drive units or motors, as well as a first drive 210 and a second drive 211, are connected to an electrical system 270 of a motor vehicle, using two-sided contactable bent-off four-pole plugs or plug connections 280 for first drive 210 and a one-sided contactable four-pole plug or plug connection 292 for second drive 211.

Two-sided contactable, bent-off, four-pole plug or plug connection 280 comprises, as a central element, a two-sided contactable multipolar plug 281 (double plug) that is integrated into first drive 210.

In addition, two-sided contactable plug connection 280 comprises a four-pole one-sided contactable electrical system plug 282 that is connected to electrical system 270 at one side via a cable 240.

Cable 240 bundles four lines, of which two lines are used for the main power supply, in this case (±) lines of a battery power supply. The remaining two lines are control and bus lines of a vehicle electronics system.

At the other side, electrical system plug 282 can be plugged to a first contact side 260 of two-sided contactable four-pole plug 281.

The plugged contact between electrical system plug 282 and two-sided contactable bent-off plug 281 is created via four pole contacts 250 to 253 the connection between the electrical system and two-sided contactable plug 281.

Because this plug 281 is additionally connected to first drive 210 via the integrated connection, first drive 210 is thereby connected to electrical system 270, and is supplied via this connection with energy and with control and communication signals.

Correspondingly, drive shaft 290 is set into rotation, which is transferred to a blower or fan.

In addition, two-sided contactable bent-off plug connection 280 comprises a first one-sided contactable four-pole plug connector 283 that is connected to a connecting cable 285 at the one end 262 thereof.

Connecting cable 285 is constructed in the manner of (electrical system) cable 240, and likewise bundles the four lines.

At the other end 263 of connecting cable 285, there is situated a second one-sided contactable four-pole plug connector 284

First plug connector 283 is capable of being plugged to a second contact side 261 of two-sided contactable plug 281.

Because first contact side 260 and second contact side 261 of two-sided contactable bent-off plug 281 are situated at sides of plug 281 that are situated in normal fashion to one another, a “bent-off” plug 281 results.

One-sided contactable four-pole plug or plug connection 292 is formed in that second one-sided contactable plug 284 stands in plugged contact with another one-sided contactable plug 285 that is integrated into second drive 211.

Alternatively to the additional one-sided contactable plug 285, here a second two-sided contactable bent-off (or also straight) plug 281 can be used.

Via this one-sided contactable plug connection 292, connecting cable 285, and in addition via two-sided contactable plug connection 280, second drive 211 is also connected to vehicle electrical system 270, and is supplied via this connection with energy and with control and communication signals.

Correspondingly, drive shaft 291 is set into rotation, which is transferred to a blower or fan.

As is shown in FIG. 6, the manufacture 600 of two-sided contactable bent-off plug 281 for plug connection 280 in double-fan system 200 takes place according to the following steps 601 to 603:

In a first step 601, illustrated by drawings 610 to 630, a flat conductor piece 611 is cut to length and is correspondingly formed to a contact shape.

Here, two additional flat conductors 612 and 613 result, of which one is bent off at a right angle in a second step 602, illustrated by 640 and 650.

If one contact side is to be constructed as a contact jack, this is to be realized through the additional attachment of a contact jack, for example by welding.

This is to be carried out for all contacts in the same manner, so that a complete multi-contact plug unit results.

In a third step 603, illustrated by 660, the processed flat conductor piece, formed as a contact unit, is extrusion-sheathed with plastic, forming a plug housing.

A third exemplary embodiment of the present invention, a sample switching diagram for a “direct” multiple-fan system having two-sided contactable plug connections, is now described with reference to FIG. 3.

FIG. 3 shows a drawing of the sample switching diagram in the multiple-fan system having two-sided contactable plug connections 310 and 311, electric drives 330 and 331 of the system each being connected directly to an electrical system 350 of a motor vehicle using two-sided contactable plug connections 310 and 311, or two-sided contactable plugs (double plugs) 320 and 321.

Two-sided contactable plug 320 or 321 is wired in such a way that both the contacting 332 or 333 to drive 330 or 331, and also the contacting 340 or 341 for forwarding via corresponding line connecting node 350, is connected directly to terminal contacting 360 or 361.

A fourth exemplary embodiment of the present invention, a sample switching diagram of an “indirect” multiple-fan system having two-sided contactable plug connections, is now described with reference to FIG. 4.

FIG. 4 shows a drawing of the sample switching diagram in the multiple-fan system having two-sided contactable plug connections 410 and 411, electric drives 430 and 431 of the system each being connected indirectly to an electrical system 450 of a motor vehicle using two-sided contactable plug connections 410 and 411 or two-sided contactable plugs (double plugs) 420 and 421.

Two-sided contactable plug 420 or 421 is wired in such a way that the contacting 432 or 433 to drive 430 or 431, as well as the contacting 440 or 441 for forwarding, is connected partly directly (for energy supply) via corresponding line connecting node 450, and partly indirectly (for communication) to terminal contacting 460 or 461.

A fifth exemplary embodiment of the present invention, a sample switching diagram for a double-fan system with connected actuator having two-sided contactable plug connections, is now described with reference to FIG. 8.

FIG. 8 shows a drawing of sample switching diagram 800 in the multiple-fan system with the connected actuator, having two-sided contactable plug connections 810 and 811, electric drives 830 and 831 of the system each being connected indirectly to an electrical system 850 of a motor vehicle using two-sided contactable plug connections 810 and 811, or two-sided contactable plugs (double plugs) 820 and 821.

A sixth exemplary embodiment of the present invention, another sample switching diagram for a double-fan system with connected actuator, having two-sided contactable plug connections, is now described with reference to FIG. 9.

FIG. 9 shows a drawing of sample switching diagram 900 for the multiple-fan system having the connected actuator, with the two-sided contactable plug connections 910 and 911, electric drives 930 and 931 of the system being connected to an electrical system 950 of a motor vehicle using two-sided contactable plug connections 910 and 911, or two-sided contactable plugs (double plugs) 920 and 921.

The wiring of the two drives, or fan drives, 930 and 931 corresponds to a combination of the wiring patterns of the drives in the multiple-fan system according to FIG. 4 and FIG. 5.

In place of an additional drive, in this double-fan system with connected actuator an actuator 901 is connected to second drive 931 by means of double plug connector 911, as shown.

Without limitation of generality, here it is to be noted that the two-sided contactable plug connections in the third to sixth exemplary embodiments can each be realized both, in the realization according to the first exemplary embodiment, as two-sided contactable straight plug connections and also, according to the second exemplary embodiment, as two-sided contactable bent-off plug connections.

It is also expressly noted here that the same holds correspondingly for the first and the second exemplary embodiment with reference to the sample switching diagrams according to the third to sixth exemplary embodiments.

The two-sided contactable straight and bent-off plug connections according to the first and the second exemplary embodiment can be wired both according to the sample switching diagram according to exemplary embodiments 3 and 4 and also according to the sample switching diagram according to exemplary embodiments 5 and 6.

1. A device for connecting an electric drive to at least one supply network, comprising:
a first contact unit to which at least one first line of the at least one supply network is able to be connected;
a second contact unit to which the electric drive is able to be connected;
the first contact unit being connected to the second contact unit in such a way that a line connection is able to be created between the at least one supply network and the electric drive;
a third contact unit to which at least one second line of the at least one supply network is able to be connected; and
the third contact unit being connected to the first contact unit or to the second contact unit in such a way that a direct or indirect line connection is able to be created between the at least one second line and the at least one supply network.

2. The device as recited in claim 1, wherein
a plurality of first lines are able to be connected to the first contact unit and/or a plurality of second lines are able to be connected to the second contact unit.

3. The device as recited in claim 1, wherein
the at least first and/or the at least second line is a power supply line or a communication line.

4. The device as recited in claim 1, wherein
the at least one supply network is a power supply network or a communication network, in particular a bus system or a control network.

5. The device as recited in claim 1, wherein
the first, second, and/or third contact unit has at least one plug contact.

6. The device as recited in claim 1, wherein
the first, second, and/or third contact unit is set up to accept a contact plug.

7. The device as recited in claim 1, wherein
the second contact unit is integrated into the electric drive.

8. The device as recited in claim 1, wherein
the at least second line is connected to an additional electrical subsystem, in particular an additional drive or an actuator.

9. The device as recited in claim 1, wherein
the electric drive and/or the additional electric drive is a electric motor, in particular an electric motor of an electric fan.

10. The device as recited in
claim 1, wherein
the device is used for cooling and/or air conditioning, in particular of a passenger compartment of a motor vehicle or of an engine of a motor vehicle, the electric drive being an electric motor of an electric fan or air-conditioning blower.

11. The device as recited in claim 1, wherein
the device is a multipolar, in particular a two-pole, three-pole, or four-pole, plug system, in particular a multipolar double plug.

12. A method for manufacturing a device for connecting an electric drive to at comprising:
a metallic flat conductor is divided along a predeterminable dividing line in a predeterminable area at a first end of the metallic flat conductor, a first longitudinal segment of the metallic flat conductor being formed having a first free end and a second longitudinal segment of the metallic flat conductor being formed having a second free end;
at the first free end the first contact unit is set up and at the second free end the second contact unit is set up; and
at a second end of the metallic flat conductor, the second contact unit is set up.

13. The method as recited in claim 12,
wherein
the metallic flat conductor is made of a metal based on copper.

14. The method as recited in claim 12,
wherein
the first and/or the second longitudinal segment is bent.

15. The method as recited in
claim 12, wherein
the metallic flat conductor is extrusion-coated, in particular with a plastic.

16. The method as recited in claim 13, wherein the first and/or the second longitudinal segment is bent.

17. The method as recited in claim 13, wherein the metallic flat conductor is extrusion-coated, in particular with a plastic.

18. The method as recited in claim 14, wherein the metallic flat conductor is extrusion-coated, in particular with a plastic.
